(19) United States
(12) Patent Application Publication
(10) Pub. No.: US 2025/0108750 A1
(43) Pub. Date: Apr. 3, 2025

(54) LIGHT CONTROL DEVICE AND A NON-TRANSITORY STORAGE MEDIUM

(71) Applicant: Toyota Jidosha Kabushiki Kaisha, Toyota-shi (JP)

(72) Inventor: Keisuke KOMATSU, Okazaki-shi (JP)

(73) Assignee: Toyota Jidosha Kabushiki Kaisha, Toyota-shi (JP)

(21) Appl. No.: 18/820,482

(22) Filed: Aug. 30, 2024

(30) Foreign Application Priority Data
Sep. 29, 2023 (JP) 2023-170279

(51) Int. Cl. B60Q 1/14; H05B 47/115

(52) U.S. Cl. CPC B60Q 1/1423; H05B 47/115; B60Q 2300/45

(57) ABSTRACT

A light control device having a processor, wherein the processor is configured to execute following processes, controlling amount of light of a light unit provided in the vehicle, in response to detection results of the detection unit for monitoring the environment around the vehicle, and the monitoring result of the power balance of the power supply unit provided in the vehicle, based on the monitoring result of the power balance, in case of determining the power consumption of the power supply unit should be reduced, based on the detection result of the detection unit, calculating an adjusted irradiation level which is reduced the current irradiation level of the light unit, and reducing the amount of light of the light unit based on the adjusted irradiation level.

### FIELD

The present invention relates to a light control device and a non-transitory storage medium capable of adjusting an irradiation level of a light unit provided in a vehicle.

### BACKGROUND

In recent years, the amount of light of a light unit for a vehicle has increased, and accordingly, the power consumption of the light unit has increased. For this reason, in recent years, the light unit for the vehicle is required to be adjusted to reduce power consumption in case of the remaining amount of electricity of a power supply device such as a storage battery falls below a predetermined level while irradiating a wide range as much as possible in a normal state.

Patent Document 1 (Japanese Patent Publication No. 2022-002931A) discloses a vehicular lighting device including a control unit that changes an area to be irradiated to a high-speed state which is narrower than a normal state in case of it is determined that the vehicle is traveling on an expressway.

According to the technique described in Patent Document 1, even in case of the power consumption in the vehicle is not tight, there is a possibility of narrowing an area to be irradiated in a vehicle situation in which all lights can be turned on while traveling on an expressway. Thus, according to the technique, there is a possibility that visibility of the irradiation range is lowered at an unnecessary timing. According to the technique, since the irradiation range is changed to narrow in case of the vehicle is traveling on an expressway, there is a possibility that visibility of a vehicle parked on a road shoulder or an object existing on a deteriorated road shoulder.

An object of the present invention is to provide a light control device and a non-transitory storage medium capable of reducing power consumption by adjusting the irradiation range while irradiating an irradiation object existing around a vehicle.

### SUMMARY

According to an aspect of the present invention, there is provided a light control device including a processor, wherein the processor controls a amount of light of a light unit provided in the vehicle in accordance with a detection result of a detection unit that monitors an environment around the vehicle and a monitoring result of a power balance of a power supply unit provided in the vehicle, and in case of it is determined that the power consumption of the power supply unit should be reduced based on the monitoring result of the power balance, an adjusted irradiation level in which the current irradiation level of the light unit is reduced is calculated based on the detection result of the detection unit, and the amount of light of the light unit is reduced based on the adjusted irradiation level.

According to the present invention, it is possible to reduce power consumption by adjusting an irradiation range while irradiating an irradiation target existing around a vehicle.

### BRIEF DESCRIPTION OF THE DRAWINGS

FIG. 1 is a block diagram illustrating a configuration of a light control device according to an embodiment.

FIG. 2 is a block diagram illustrating a configuration of a light unit.

FIG. 3 is a diagram illustrating an adjusted irradiation range in which the amount of light in the irradiation range in the normal state is reduced.

FIG. 4 is a diagram illustrating an adjusted irradiation range including an irradiation target.

FIG. 5 is a flowchart illustrating a processing flow of the light control method.

### DESCRIPTION OF EMBODIMENTS

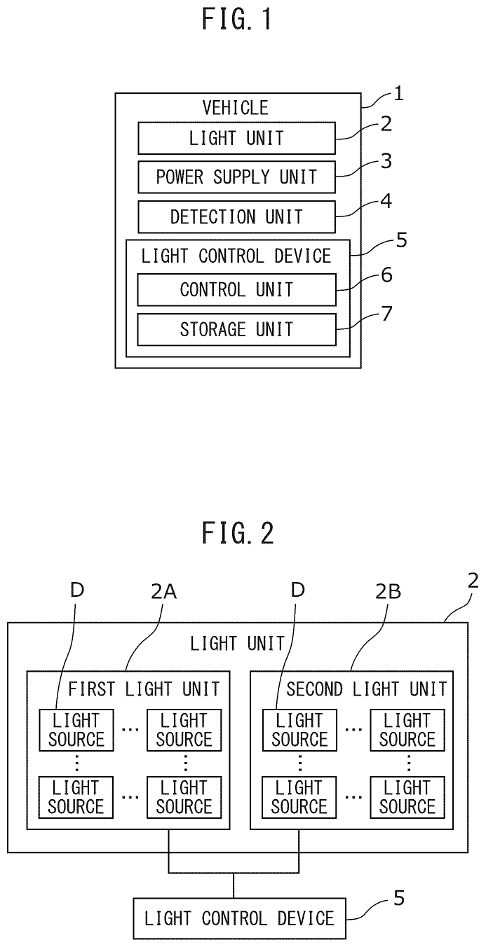

As illustrated in FIG. 1, the vehicle 1 includes a light unit 2 that irradiates a front region, a detection unit 4 that monitors an environment around the vehicle 1, and a light control device 5 that controls the light unit 2. The light unit 2 includes, for example, LED (Light Emitting Diode) light sources formed of a light-emitting device. The light-emitting device is provided with a circuit section for adjusting the amount of light. The light unit 2 is supplied with electric power from a power supply unit 3 provided in the vehicle 1. The power supply unit 3 includes, for example, a chargeable and dischargeable storage battery and a control circuit that controls charge and discharge power. The power supply unit 3 may include a power generation device such as a fuel cell. In case of the vehicle 1 is an electric vehicle, the power supply unit 3 may be configured to supply electric power not only for the light unit 2 but also for traveling for the vehicle 1.

The detection unit 4 is constituted by a plurality of sensors capable of detecting the environment around the vehicle 1. The detection unit 4 may include, for example, a camera that captures an image of the surroundings of the vehicle 1. The detection unit 4 may include, for example, a rider device that detects an object around the vehicle 1. The detection unit 4 may include, for example, a communication unit that performs inter-vehicle communication with another vehicle existing around the vehicle 1. The detection unit 4 may include, for example, a communication unit that communicates with a terminal device of a traffic participant such as a pedestrian present around the vehicle 1.

The detection unit 4 may include, for example, a position sensor that detects the current position of the vehicle 1. The detection unit 4 may include, for example, a six-axis sensor that detects the posture and acceleration of the vehicle 1. The detection unit 4 may be configured by, for example, a navigation device that calculates a path to a destination of the vehicle 1. In addition, the detection unit 4 may include a sensor used for driving and driving support of the vehicle 1. The detection unit 4 may include other sensors if it can detect information necessary for the vehicle 1 to travel. The detection unit 4 outputs the detection result of the predetermined sensor to the light control device 5.

The light control device 5 is a computer device configured to adjust the amount of light of the light unit 2. The light control device 5 includes a control unit 6 that controls the amount of light of the light unit 2, and a storage unit 7 that stores data and a computer program necessary for the control. The control unit 6 is constituted by a hardware processor such as at least one CPU (Central Processing Unit). The storage unit 7 includes a non-transitory storage medium such as a hard disk drive (HDD) or a solid-state disk (SSD).

The control unit 6 is connected to the light unit 2 and controls the circuit unit to adjust the amount of light of the light source. The control unit 6 is connected to a control circuit of the power supply unit 3 and monitors a power balance and a voltage of the power supply unit 3. The control unit 6 monitors the power balance of the power supply unit 3 based on the power consumption of the light unit 2 connected to the power supply unit 3 and the charging power input to the power supply unit 3. The control unit 6 calculates the current electric capacity of the power supply unit 3 based on the monitoring result of the voltage and the power balance of the power supply unit 3. The control unit 6 may calculate a future electric capacity of the power supply unit 3 based on a monitoring result of the voltage of the power supply unit 3 and the power balance.

In case of the vehicle 1 is an electric vehicle, the control unit 6 may calculate a future electric capacity of the power supply unit 3 and a cruising distance of the vehicle 1 based on a SOC (State of Charge) indicating a state of charge of the power supply unit 3 and power consumption by the vehicle 1. The control unit 6 determines whether the power consumption of the power supply unit 3 should be reduced based on the monitoring result of the power balance of the power supply unit 3.

For example, in case of the current voltage of the power supply unit 3 is equal to or lower than a preset threshold value, the control unit 6 determines that the power consumption of the power supply unit 3 should be reduced. In another example, the control unit 6 may determine that the power consumption of the power supply unit 3 should be reduced in case of it is predicted that the electric capacity of the power supply unit 3 is insufficient after a predetermined time has elapsed based on the current electric capacity of the power supply unit 3 and the current electric power consumption. In another example, in case of the vehicle 1 is an electric vehicle, the control unit 6 may determine, based on the present SOC of the power supply unit 3, that the power consumption of the power supply unit 3 should be reduced in case of it is predicted that the cruising distance of the vehicle 1 is insufficient to the destination.

In the normal state, the control unit 6 controls the light unit 2 to irradiate an irradiation range corresponding to an irradiation level which is a control value in the normal state. In case of the control unit 6 determines that the power consumption of the power supply unit 3 should be reduced, the control unit 6 calculates an adjusted irradiation level in which the braking irradiation level in the normal state of the light unit 2 is reduced. The adjusted irradiation level is a control value capable of reducing the power consumption compared to the current irradiation level. The control unit 6 controls the light unit 2 to calculate an adjusted irradiation range corresponding to the calculated adjusted irradiation level. The control unit 6 controls the light unit 2 to irradiate the adjusted irradiation range in which the amount of light in the irradiation range in the normal state is reduced. The adjusted irradiation range is calculated, for example, to reduce the area of the irradiation range in the normal state. The adjusted irradiation range may be calculated by decreasing the amount of light irradiated to the irradiation range in the normal state.

In the case of reducing the area of the irradiation range in the normal state, the control unit 6 controls, for example, the light unit 2 to reduce the amount of light of the light source that can be dimmed among the plurality of light sources, and to irradiate the adjusted irradiation range. In the case of irradiating the adjusted irradiation range in which the amount of light is reduced as compared with the irradiation range in the normal state, the control unit 6 may control the light unit 2 to simply reduce the amount of light in the irradiation range in the normal state to irradiate the adjusted irradiation range.

The control unit 6 calculates the adjusted irradiation range so that the irradiation target is irradiated in case of the irradiation target is detected by the detection unit 4. In a case where the irradiation target is detected by the detection unit 4, the control unit 6 calculates an adjusted irradiation range that does not irradiate a region that does not include the irradiation target as compared with the irradiation range in the normal state. The irradiation target includes a traffic participant such as a pedestrian or another vehicle, an object, or a structure existing in the vicinity of a road or on a road, and the like.

The control unit 6 detects an irradiation target, for example, based on an analysis result of a captured image of a camera included in the detection unit 4. The control unit 6 detects an irradiation target, for example, based on an output value of the lidar device included in the detection unit 4. For example, the detection unit 4 detects an irradiation target such as another vehicle existing around the vehicle 1 or a traffic participant such as a pedestrian existing around the vehicle 1 based on a communication result of the communication unit included in the detection unit 4.

The control unit 6 calculates relative coordinates of the vehicle 1 and the irradiation target based on the detection value of the detection unit 4. The control unit 6 calculates an adjusted irradiation range that changes with time in accordance with the relative movement speed of the irradiation target. The control unit 6 controls the light unit 2 to irradiate the adjusted irradiation range to change with time.

As illustrated in FIG. 2, the light unit 2 includes a first light unit 2A and a second light unit 2B, that irradiate the front of the vehicles 1. The first unit 2A and a second light unit 2B are horizontally juxtaposed, for example, on the front side of the vehicle 1. The first light unit 2A includes, for example, a plurality of light sources D arranged in a matrix. The second light unit 2B includes, for example, a plurality of light sources D arranged in a matrix. The control unit 6 individually controls the amount of lights of the plurality of light sources D provided in the first light unit 2A. The control unit 6 individually controls the amount of lights of the plurality of light sources D provided in the second light unit 2B. The correspondence between each light source D and its individual irradiation range is set in advance.

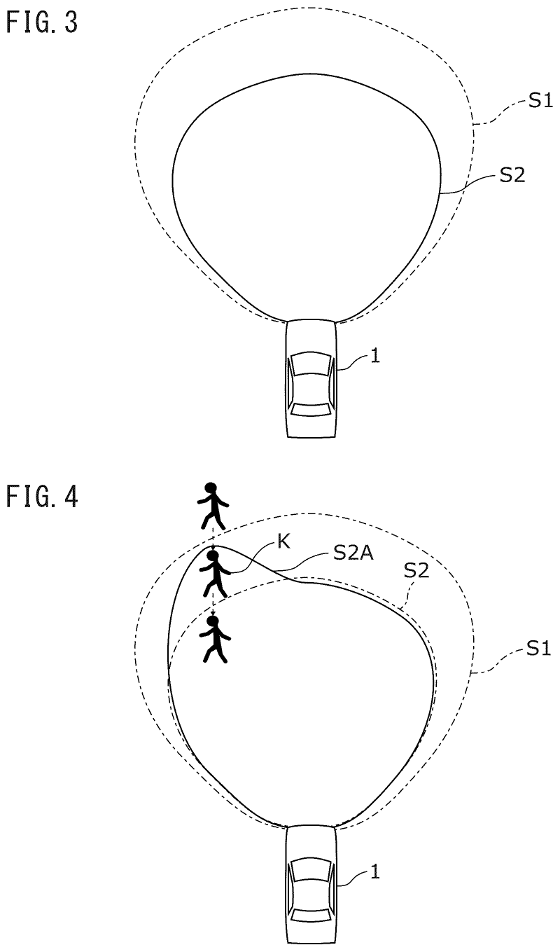

As illustrated in FIG. 3, the light unit 2 irradiates a predetermined irradiation area S1 in front of the vehicle 1. The light unit 2 irradiates a predetermined irradiation area S1 in accordance with an irradiation level in a normal state. In case of it is determined that the power consumption should be reduced, the control unit 6 irradiates the adjusted irradiation range S2 in which the irradiation range S1 is reduced. The light unit 2 irradiates the adjusted irradiation area S2 in accordance with the adjusted irradiation level. In the normal condition, the control unit 6 individually controls the amount of light of the plurality of light sources D provided in the first light unit 2A to be the normal amount of light, and individually controls the amount of light of the plurality of light sources D provided in the second light unit 2B so as to be the normal amount of light, thereby irradiating a predetermined illumination area S1 in front of the vehicle 1.

In case of determining that the amount of power consumed should be reduced, the control unit 6 individually controls the amount of light of the plurality of light sources D provided in the first light unit 2A and individually controls the amount of light of the plurality of light sources D provided in the second light unit 2B to irradiate the adjusted irradiation range S2 in which the amount of light in the predetermined irradiation range S1 in front of the vehicle 1 is reduced. The control unit 6 reduces the amount of light of the dimmable light source D among the plurality of light sources D provided in the first light unit 2A and the plurality of light sources D provided in the second light unit 2B to irradiate the adjusted illumination area S2. For example, the control unit 6 causes the light unit 2 to irradiate the adjusted illumination area S2 by individually switching between the on-state and the off-state of the light source D. The control unit 6 may cause the light unit 2 to irradiate the adjusted illumination area S2 by individually reducing the amount of light of the light source D as well as the off state. Based on the above process, the light control device 5 can reduce power consumption by causing the light unit 2 to irradiate the adjusted emission area S2.

As shown in FIG. 4, in case of the control unit 6 determines that the power consumption should be reduced, and in case of the irradiation object K is detected by the detection unit 4, the control unit 6 causes the light unit 2 to irradiate the adjusted irradiation area S2A in which the irradiation object K is included, and the area not included in the irradiation object K is reduced. The control unit 6 individually controls the amount of light of the plurality of light sources D provided in the first light unit 2A to be the normal amount in the normal condition, and individually controls the amount of light of the plurality of light sources D provided in the second light unit 2B to be the normal amount, thereby irradiating a predetermined illumination area S1 in front of the vehicle 1.

The control unit 6 individually controls the amount of light of the plurality of light sources D provided in the first light unit 2A and individually controls the amount of light of the plurality of light sources D provided in the second light unit 2B to irradiate the adjusted irradiation range S2A in which the amount of light in the predetermined irradiation range S1 in front of the vehicle 1 is reduced. The control unit 6 reduces the amount of light of the dimmable light source D among the plurality of light sources D provided in the first light unit 2A and the plurality of light sources D provided in the second light unit 2B to irradiate the adjusted illumination area S2A. For example, the control unit 6 causes the light unit 2 to irradiate the adjusted illumination area S2 by individually switching between the on-state and the off-state of the light source D. The control unit 6 may cause the light unit 2 to emit the adjusted emission area S2A by individually reducing the amount of light of the light source D.

The control unit 6 controls the light unit 2 over time to irradiate the adjusted irradiation range S2A from the irradiation range S1 in the normal condition in accordance with a change in the relative coordinates of the irradiation object K over time. In case of the irradiation object K approaches the relative coordinates included in the adjusted irradiation range S2, the control unit 6 changes the adjusted irradiation range S2A to the adjusted irradiation range S2 because the irradiation object K can be visually recognized. Based on the above process, in case of the irradiation object K is detected, the light control device 5 can cause the light unit 2 to irradiate the irradiation object K with the adjusted irradiation area S2A. The light control device 5 can improve the visibility of the irradiation object K while reducing the power consumption by irradiating the adjusted irradiation area S2A that irradiates the irradiation object K.

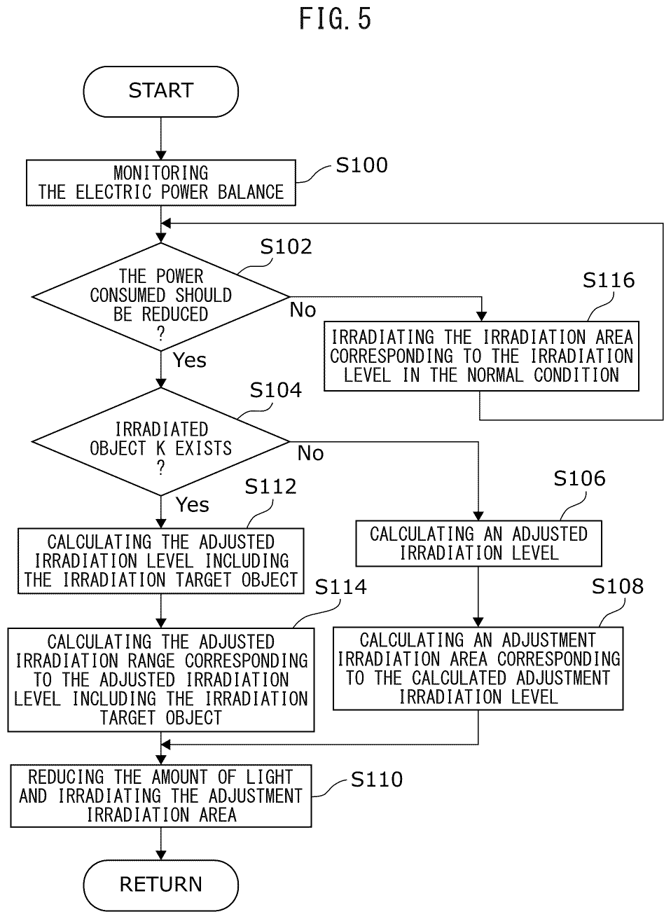

FIG. 5 shows a flow of processing of the light control method executed in the light control device 5. The light control method is executed by a computer program mounted on the light control device 5. In case of the light unit 2 is in the on-state, the control unit 6 monitors the electric power balance of the light unit 2 (S100). The control unit 6 determines whether the power consumed by the light unit 2 should be reduced based on the monitoring of the power balance of the light unit 2 (S102).

In case of it is determined that the power consumption of the light unit 2 should be reduced, the control unit 6 determines whether the irradiated object K exists around the vehicle 1 based on the monitoring result of the detection result of the detection unit that monitors the environment around the vehicle (S104). In case of it is determined that the irradiation object K does not exist around the vehicle 1, the control unit 6 calculates an adjusted irradiation level obtained by reducing the current irradiation level of the light unit 2 (S106). The control unit 6 calculates an adjustment irradiation area corresponding to the calculated adjusted irradiation level (S108). The control unit 6 reduces the amount of light of the light unit 2 based on the adjusted irradiation level and causes the adjustment irradiation area to be irradiated (S110).

In case of it is determined in S104 that the irradiation object K exists around the vehicle 1, the control unit 6 calculates the adjusted irradiation level including the irradiation object K (S112). The control unit 6 calculates the adjusted irradiation range corresponding to the adjusted irradiation level including the irradiation object K (S114). The control unit 6 reduces the amount of light of the light unit 2 based on the adjusted irradiation level including the irradiation object K and causes the adjusted irradiation range to be irradiated (S110).

In case of it is determined in S102 that the power consumed by the light unit 2 does not need to be reduced, the control unit 6 causes the irradiation area corresponding to the irradiation level in the normal condition to be irradiated (S116) and continues S102 determination process. The light control device 5 repeatedly executes the above processing in the lighting state of the light unit 2.

As described above, according to the light control device 5, in case of it is necessary to reduce the power consumption of the light unit 2, it is possible to reduce the power consumption by reducing the amount of light of the light unit 2. According to the light control device 5, in case of the irradiation object K exists around the vehicle 1, it is possible to reduce the power consumption by controlling the light unit 2 to irradiate the irradiation object K and by irradiating the adjusted irradiation range in which the irradiation range is reduced.

In the above-described embodiment, the computer program executed in each configuration of the light control device 5 may be provided in a form recorded in a non-transitory computer-readable recording medium such as a semiconductor memory, a magnetic recording medium, or an optical recording medium. In the embodiments described above, various additions, substitutions, changes, partial deletions, and the like can be made without departing from the gist of the invention or without departing from the spirit and spirit of the invention derived from the contents described in the claims and equivalents thereof.

For example, the first light unit 2A may be constituted by one light source, and the second light unit 2B may also be constituted by one light source D. In this case, the light control device 5 may perform control to reduce the amount of light of one light source D of the first light unit 2A and the amount of light of one light source D of the second light unit 2B. The light unit 2 may be constituted by a single first light unit 2A. The light unit 2 may be constituted by other light sources if the light source is capable of adjusting the amount of light such as a light source HID (High-Intensity Discharge), a laser light source, or a halogen-bulb light source, as well as a LED light source. The amount of light of the light source D in the normal state may be changed in accordance with the amount of light of the environment surrounding the vehicle 1.

The light control device 5 may be applied not only to an electric vehicle but also to a vehicle having an internal combustion engine. The light control device may be applied to a hybrid vehicle including an internal combustion engine. The light control device may be applied to a vehicle including not only four wheels but also two wheels and four or more wheels. The light control device 5 may be applied to an automated driving vehicle or a manual driving vehicle. The light control device 5 may be applied to a human-powered vehicle such as a bicycle.

1. A light control device having a processor, wherein the processor is configured to execute following processes:
controlling amount of light of a light unit provided in the vehicle, in response to detection results of the detection unit for monitoring the environment around the vehicle, and the monitoring result of the power balance of the power supply unit provided in the vehicle;
based on the monitoring result of the power balance, in case of determining the power consumption of the power supply unit should be reduced, based on the detection result of the detection unit, calculating an adjusted irradiation level which is reduced the current irradiation level of the light unit; and
reducing the amount of light of the light unit based on the adjusted irradiation level.

2. The light control device according to claim 1, wherein the processor is configured to execute following processes:
controlling the light unit comprising a plurality of light sources for illuminating a predetermined illumination range corresponding to the current irradiation level;
in the adjustment of the amount of light according to the adjusted irradiation level, based on the detection result of the detection unit, calculating an adjusted irradiation range reduced irradiation range; and
reducing the amount of light of the dimmable light source among the plurality of light sources to illuminate the adjusted illumination range.

3. The light control device according to claim 2, wherein the processor is configured to execute following process:
in case of an irradiation object is detected by the detection unit, calculating the adjusted irradiation range so that the irradiation object is irradiated.

4. The light control device according to claim 3, wherein the processor is configured to execute following process:
in case of the irradiation object is detected by the detection unit, calculating the adjusted irradiation range so as not to irradiate a region where the irradiation object is not included compared with the irradiation range.

5. A non-transitory storage medium storing a computer program, which cause a processor of a computer to execute following processes:
controlling amount of light of a light unit provided in the vehicle, in response to detection results of the detection unit for monitoring the environment around the vehicle, and the monitoring result of the power balance of the power supply unit provided in the vehicle;
based on the monitoring result of the power balance, in case of determining the power consumption of the power supply unit should be reduced, based on the detection result of the detection unit, calculating an adjusted irradiation level which is reduced the current irradiation level of the light unit; and
reducing the amount of light of the light unit based on the adjusted irradiation level.
